(19) United States
(12) Patent Application Publication
(10) Pub. No.: US 2019/0301426 A1
(43) Pub. Date: Oct. 3, 2019

(54) MECHANISM FOR ORIENTING A SUBMERGED POWER MODULE

(71) Applicant: Ernest William Townsend, IV, Scottsdale, AZ (US)

(72) Inventor: Ernest William Townsend, IV, Scottsdale, AZ (US)

(21) Appl. No.: 16/365,267

(22) Filed: Mar. 26, 2019

Related U.S. Application Data
(60) Provisional application No. 62/649,427, filed on Mar. 28, 2018.

(51) Int. Cl. F03B 13/12

(52) U.S. Cl. CPC F03B 13/12

(57) ABSTRACT

A system is provided for directing a power module along a path through air, and then through water, during a machine duty cycle. On a power portion of the path, as the module falls through air from a start point under the influence of gravity, it engages with a generator to generate electric power. The module then enters a water tank where it is decelerated to zero velocity. On a return portion of the path, which is off set from the power path, the module remains submerged as it rises under the influence of buoyancy back up to its start point for the beginning of a subsequent duty cycle. Hydrodynamic features in the module design and structural features of a guideway in the water tank assist each other in directing the module through the submerged portion of its duty cycle.

This application claims the benefit of U.S. Provisional Patent Application Ser. No. 62/649,427, filed Mar. 28, 2018. The entire contents of Application Ser. No. 62/649,427 are hereby incorporated by reference herein.

### FIELD OF THE INVENTION

The present invention pertains to systems and methods for moving power modules along paths where their kinetic energy can be converted into a power output. More particularly, the present invention pertains to systems for moving power modules along a path were they alternately pass through air and through water during their duty cycle. The present invention is particularly, but not exclusively, useful for directing a power module along a path where it is alternately propelled by the force of gravity to generate power during a power phase, and is propelled by the force of buoyancy during a return phase to reposition the power module for a subsequent power phase.

### BACKGROUND OF THE INVENTION

It is well known that the forces of gravity and buoyancy result from the earth's gravitational field. Specifically, gravity is the force by which an object is attracted toward the center of the earth. For example, the weight of an object, W, is a measure of the magnitude of the gravitational attraction on the object. On the other hand, buoyancy, B, is a force that moves an object away from the center of the earth. In the context of the present invention, gravity and buoyancy are used alternatingly.

Of particular interest for the present invention is the question of how an object (e.g. power module) can be effectively moved in opposite directions through a fluid medium; be it either a gas or a liquid. It happens, however, that the aerodynamic and hydrodynamic considerations for the movement of the object are similar. Specifically, both considerations involve an understanding of the forces acting on the object as it moves. On this point, it is helpful to note that all forces can be characterized as having both a direction and a magnitude. Importantly, these force characteristics are related to the shape of the object and to its drag characteristics, i.e. its resistance to movement through a medium.

From an engineering perspective, the movement of an object in a fluid medium is significantly influenced by considerations of the object's shape and its coefficient of drag, C_{D}. In detail, C_{D} is specific for each object, and it has an important influence on the velocity of the object. Additionally, the direction of movement that is taken by an object as it travels through a medium under the influence of gravity or buoyancy can be greatly affected by the shape of the object. Thus, both the shape of an object and its C_{D} are important design considerations for the object.

For the present invention, it is important to recognize that throughout its operation, a power module will remain substantially upright. Stated differently, a top end of the power module always remains above a lower end of the power module. With this in mind, it is important to also appreciate that the power module will travel in both upward and downward directions during a duty cycle. Consequently, the top end will lead some of the time, and the lower end will lead the rest of the time. Thus, the C_{D} and the shape of the top end and the bottom end will typically be different from each other.

In light of the above, it is an object of the present invention to provide a system for moving power modules along a path where its kinetic energy can be converted into a power output. Another object of the present invention is to design a power module with a top end having a predetermined coefficient of drag for movement through water and a bottom end having a different coefficient of drag. Still another object of the present invention is to design a power module with top and bottom ends for travel through a bi-level tank, wherein the bottom end is designed to decelerate in the bi-level tank under the influence of gravity, and the top end is designed to accelerate in the bi-level tank under the influence of buoyancy. Yet another object of the present invention is to provide a system for moving power modules along a path where its kinetic energy can be converted into a power output, wherein the system is easy to manufacture, is simple to operate and is comparatively very cost effective.

### SUMMARY OF THE INVENTION

In accordance with the present invention, a system is provided for orienting and guiding a submerged module as it shuttles downwardly and upwardly through a bi-level tank. Structurally, the module defines an axis and it has an upper end, a lower end and a body portion that is located between its upper and lower ends. An important hydrodynamic feature of the module is that it remains substantially upright as it travels up and down through the bi-level tank.

Because the module remains upright as it travels through the bi-level tank, its lower end will have an effective coefficient of drag C_{D(lower)}, which is designed for optimal deceleration of the module during its downward movement in the bi-level tank. On the other hand, the upper end of the module will have an effective coefficient of drag C_{D(upper)}, which is designed for optimal acceleration to a predetermined velocity during an upward movement of the submerged module in the bi-level tank. For a preferred embodiment of the present invention, both coefficients of drag can be engineered to be different, with C_{D(lower)}>C_{D(upper)}. Also, a guideway is established in the bi-level tank for maintaining the upright orientation of the module and for directing it along the guideway through the bi-level tank.

An additional feature of the module is that its lower end is formed with a planar surface which is inclined at a slant angle α relative to the module's axis. Functionally, the slanted surface introduces a moment on the module as it moves downwardly under the influence of gravity in the bi-level tank. The result of this moment is that the axis of the module is briefly rotated through an angle ϕ measured from vertical. Thus, as it subsequently moves upwardly through the bi-level tank, the module is initially directed onto an off-set path for a buoyant movement upwardly through the bi-level tank.

Functionally, the guideway directs and orients the module on a path as it moves through the bi-level tank. Structurally, the guideway can be a combination of mechanical rails or chutes that will physically guide the module in the bi-level tank. The guideway can also include a system of magnets that will continuously influence the orientation of the module. Most likely, the guideway will include both mechanical and magnetic aspects.

In a preferred embodiment of the present invention, the guideway will include a submerged arresting guide that is positioned to receive the module inside the bi-level tank as it enters and decelerates in the bi-level tank. Specifically, the arresting guide is preferably oriented at the rotation angle ϕ for arresting the downward movement of the module in the bi-level tank. Additionally, there is a pivot guide mounted on the arresting guide for rotation between first and second orientations. Operationally, its function is two-fold. In the first orientation the pivot guide is used to direct the module onto the arresting guide as the module descends into the bi-level tank. In its second orientation, the pivot guide is used to direct the module from the arresting guide for further upward travel through the bi-level tank.

Additionally, the guideway can include guideway magnets that are positioned at predetermined locations along the guideway. For this aspect of the invention at least one module magnet will also be mounted on the module. The module magnet(s) and the guideway magnet(s) will then interact with each other to direct and orient the module as it travels through the bi-level tank.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1A is a front elevation view of a module in accordance with the present invention;

FIG. 1B is a side elevation view of the module shown in FIG. 1A;

FIG. 2A is a schematic presentation of the module descending under the influence of gravity into a bi-level tank via a lower surface, for deceleration to rest on an arresting guide in the tank; and

FIG. 2B is a schematic presentation of the module ascending in the bi-level tank under the influence of its buoyancy for exit from the bi-level tank via an upper surface.

### DESCRIPTION OF THE PREFERRED EMBODIMENTS

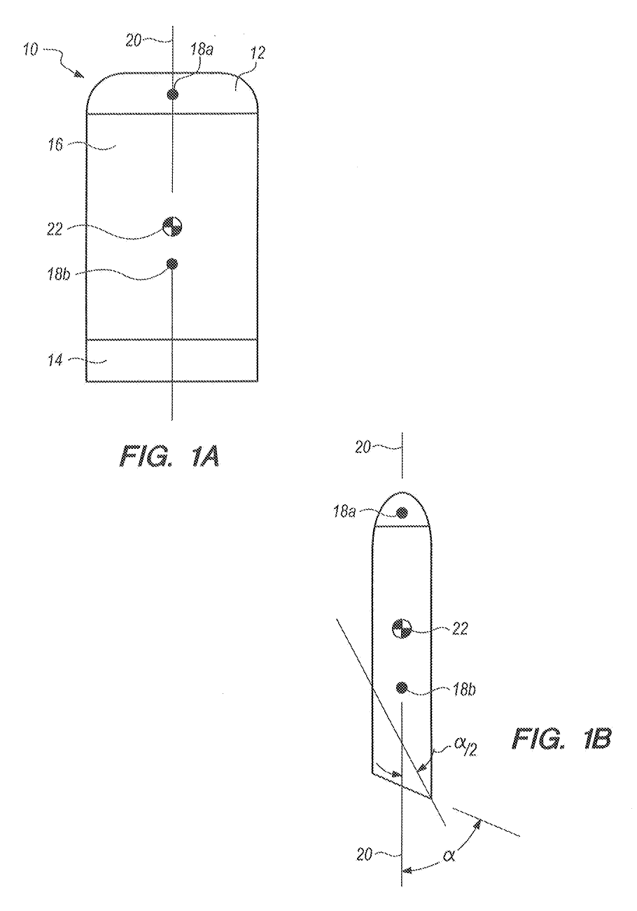

Referring initially to FIG. 1A, a module for use with the present invention is shown and is generally designated 10. As shown, the module 10 has an upper end 12 and a lower end 14, with a body portion 16 positioned between the ends 12 and 14. FIG. 1A also shows that the module 10 may optionally include module magnets 18a and 18b which can be positioned at predetermined locations inside the module 10. The locations for module magnets 18a and 18b shown on the module 10 in FIG. 1A are only exemplary.

It is to be appreciated that various shapes for the body portion 16 of the module 10 are envisioned. There are, however, several design features that deserve special consideration. One is the weight, W, of the module 10. For instance, when a module 10 is to be used for the purpose of generating electric power, the present invention envisions that W may be as much as several tons. For another, the buoyancy factor, B, of the module 10 is important. In particular, for purposes of the present invention, B will preferably be in a range somewhere between 0.60 and 0.75. In any event, the module 10 will define an axis 20, substantially as shown in FIGS. 1A and 1B, and it will have a center of pressure 22 which will be pertinent for hydrodynamic design considerations for the module 10.

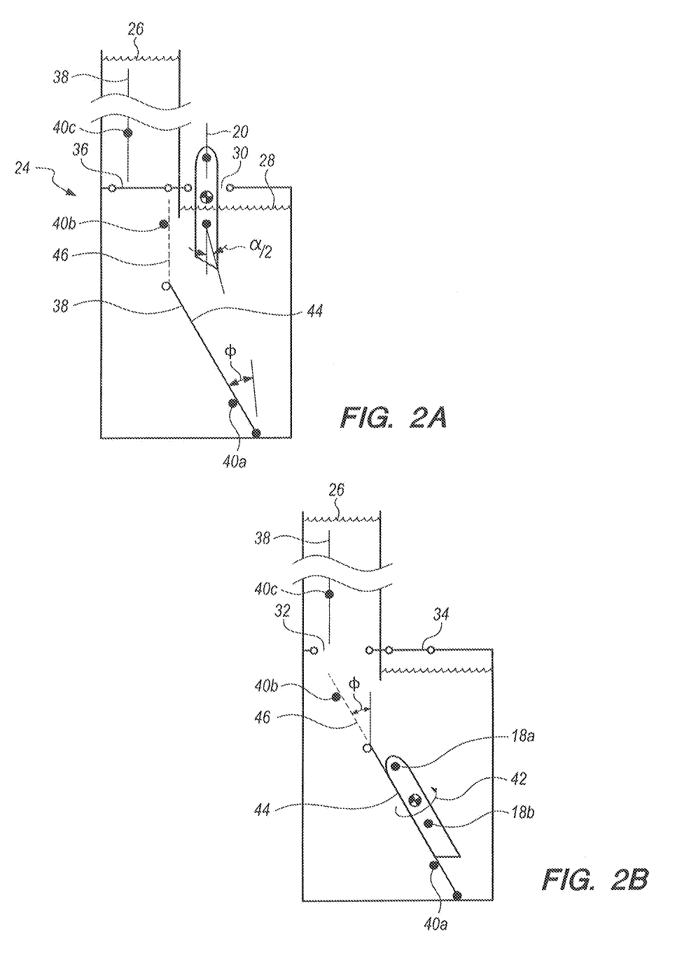

With reference to FIG. 2A, it is to be appreciated that the module 10 is intended to be used primarily with a bi-level tank which has been generally designated 24. Briefly, for purposes of this disclosure, the bi-level tank 24 is intended to hold water and have both an upper surface 26, and a lower surface 28. Further, as shown, the bi-level tank 24 includes an access port 30 for receiving the module 10 as it falls downwardly for entry into the bi-level tank 24 through the lower surface 28. As best seen in FIG. 2B, the bi-level tank 24 also includes a transfer port 32 which is located inside the bi-level tank 24, and is submerged therein between the upper surface 26 and the lower surface 28. An access valve 34 and a transfer valve 36 are respectively associated with the access port 30 and the transfer port 32. The valves 34 and 36 may be of any type valve known in the pertinent art and, in combination, they function as a valve mechanism. As a valve mechanism the valves 34 and 36 are alternately operated open/close and close/open to maintain a predetermined height difference between the upper surface 26 and the lower surface 28. In this combination, it is an important functional consideration that the access port 30 and the transfer port 32 are never open at the same time.

In accordance with the present invention, the module 10 remains upright as it travels through the bi-level tank 24. Thus, the upper end 12 of the module 10 will always be above its lower end 14. Consequently, because the module 10 moves both up and down in the bi-level tank 24, both ends 12 and 14 require hydrodynamic considerations. In detail, the upper end 12 will need to establish an effective coefficient of drag C_{D(lower)}, which is designed for optimal deceleration of the module 10 during its downward movement in the bi-level tank 24. On the other hand, the upper end 14 of the module will need to have an effective coefficient of drag C_{D(upper)}, which is designed for optimal acceleration of the module 10 to a predetermined velocity during an upward movement of the submerged module 10 in the bi-level tank 24. For a preferred embodiment of the present invention, both coefficients of drag are engineered to be different with C_{D(lower)}>C_{D(upper)}.

A guideway 38 is also established in the bi-level tank 24 for maintaining the upright orientation of the module 10 and for directing it along the guideway 38 through the bi-level tank 24. To assist the guideway 38 in this function, a plurality of guideway magnets 40, of which the guideway magnets 40a, 40b and 40c are only exemplary, can be incorporated along the guideway 38. Specifically, guideway magnets 40a-c need to be positioned at predetermined points on the guideway 38 which will optimize their interaction with the module magnets 18a-b.

Referring back to FIGS. 1A and 1B, it will be seen that the lower end 14 of the module 10 is formed as a generally planar surface defining a slant plane that is inclined at a slant angle α relative to the module axis 20. The purpose of the slant angle α is to introduce a moment 42 (see FIG. 2B) on the module 10, as the module 10 moves downwardly under the influence of gravity in the bi-level tank 24. The moment 42 will then rotate the module 10 into contact with an arresting guide 44 on the guideway 38 which is oriented at an angle ϕ measured from vertical. Also, for purposes of initially guiding the module 10 in buoyancy through the bi-level tank 24 toward the transfer port 32, a pivot guide 46 is rotated through the angle ϕ as shown. Thus, the module 10 is guided by the pivot guide 46 into a proper orientation on the guideway 38 for exit from the bi-level tank 24. Preferably, the slant angle α will be less than 45°, and the rotation angle ϕ will be in a range between 20° and 45°.

While the particular Mechanism for Orienting a Submerged Power Module as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A system for orienting a submerged module which comprises:
a module defining an axis and having an upper end, a lower end and a body portion located therebetween;
a bi-level tank for holding water in the bi-level tank with an upper surface and a lower surface, wherein the bi-level tank includes an access port for receiving the module as the module falls downwardly into the bi-level tank through the lower surface, wherein the bi-level tank includes a submerged transfer port located inside the bi-level tank between the upper surface and the lower surface for passing the module therethrough as the module rises upwardly in the bi-level tank for exit therefrom through the upper surface, wherein the lower end of the module has an effective coefficient of drag C_{D(lower)} during a downward movement of the submerged module in the bi-level tank, and the upper end of the module has an effective coefficient of drag C_{D(upper)} during an upward movement of the submerged module in the bi-level tank, wherein C_{D(lower)}>C_{D(upper)};
a valve mechanism including a first valve for opening/closing the access port and a second valve for alternately closing/opening the transfer port, wherein the access port and the transfer port are never open at the same time; and
a guideway established in the bi-level tank for directing the module along the guideway from the access port to the transfer port.

2. The system recited in claim 1 wherein the lower end of the module is formed with a planar surface defining a slant plane inclined at a slant angle α relative to the module axis, wherein the slant plane introduces a moment on the module as it moves downwardly under the influence of gravity in the bi-level tank to rotate the axis of the module through an angle ϕ measured from vertical, and wherein the rotation angle ϕ moves the module into a proper orientation for subsequent buoyant movement of the module toward the transfer port.

3. The system recited in claim 2 wherein the slant angle α is less than 45°.

4. The system recited in claim 2 wherein the rotation angle ϕ is established in a range between 20° and 45°.

5. The system recited in claim 2 wherein the body portion is formed with a first side and a second side, wherein the first and second sides respectively extend between the upper end and the lower end of the module, are parallel to each other, and are equidistant from the axis of the module.

6. The system recited in claim 2 wherein the guideway includes a submerged arresting guide mounted inside the bi-level tank below the access port and oriented therein at the rotation angle ϕ relative to vertical for arresting the downward movement of the module in the bi-level tank.

7. The system recited in claim 6 further comprising:
a pivot guide mounted on the arresting guide for rotation between a first orientation for directing the module onto the arresting guide as the module descends into the bi-level tank, and a second orientation for directing the module from the arresting guide through the transfer port for exit from the bi-level tank; and
a motor for activating the pivot guide between its first and second orientations.

8. The system recited in claim 1 wherein the transfer port is level with the access port.

9. The system recited in claim 1 wherein the module has a buoyancy factor in a range between 0.60 and 0.75.

10. The system recited in claim 1 further comprising:
at least one module magnet mounted on the module; and
at least one guideway magnet mounted on the guideway, wherein the module magnet and the guideway magnet interact with each other to direct the module toward the transfer port.

11. A module for sequentially moving along a predetermined path through a liquid medium, first in a downward direction and then in an upward direction, wherein the module defines an axis and has an axial length L, the module comprising:
a lower end having a hydrodynamic coefficient of drag C_{D(lower)}, wherein C_{D(lower)} is established to decelerate the module in the liquid medium under the influence of gravity, from a predetermined velocity Vₑ upon entry into the liquid medium, to a zero velocity in the liquid medium, wherein deceleration occurs within a distance of 4 L;
an upper end having a hydrodynamic coefficient of drag C_{D(upper)}, wherein C_{D(upper)} is established to accelerate the module in the liquid medium under the influence of buoyancy to a terminal velocity Vₜ within a distance of 4 L for exit of the module from the liquid medium at the velocity Vₜ, wherein C_{D(lower)}>C_{D(upper)}; and
a body portion located between the upper end and the lower end of the module, wherein the body portion is formed with a first side and a second side, wherein the first and second sides respectively extend between the upper end and the lower end of the module, are parallel to each other, and are equidistant from the axis of the module.

12. The module recited in claim 11 wherein the lower end of the module is formed with a planar surface defining a slant plane inclined at a slant angle α relative to the module axis, wherein the slant plane introduces a moment on the module as it moves downwardly under the influence of gravity in the bi-level tank to rotate the axis of the module through an angle ϕ measured from vertical, and wherein the rotation angle ϕ moves the module into a proper orientation for subsequent buoyant movement of the module.

13. The module recited in claim 12 wherein the slant angle α is less than 45°.

14. The module recited in claim 12 wherein the angle ϕ is established in a range between 20° and 45°.

15. The module recited in claim 11 wherein the liquid medium is held in a bi-level tank having an upper surface and a lower surface, wherein the bi-level tank includes an access port for receiving the module as the module falls downwardly into the bi-level tank with the predetermined velocity Vₑ through the lower surface, wherein the bi-level tank includes a submerged transfer port located inside the bi-level tank between the upper surface and the lower surface for passing the module therethrough as the module rises upwardly in the bi-level tank for exit therefrom via the upper surface at the terminal velocity Vₜ.

16. A method for manufacturing a system for orienting a submerged module which comprises the steps of:
providing a module defining an axis and having an upper end, a lower end and a body portion located therebetween;
building a bi-level tank for holding water, wherein water in the bi-level tank has an upper surface and a lower surface, wherein the bi-level tank includes an access port for receiving the module as the module falls downwardly into the bi-level tank through the lower surface, wherein the bi-level tank includes a submerged transfer port located inside the bi-level tank between the upper surface and the lower surface for passing the module therethrough as the module rises upwardly in the bi-level tank for exit therefrom through the upper surface; and
installing a valve mechanism in the bi-level tank, wherein the valve mechanism includes a first valve for opening/closing the access port and a second valve for alternately closing/opening the transfer port, wherein the access port and the transfer port are never open at the same time and wherein the transfer port is level with the access port; and
mounting a guideway inside the bi-level tank for directing the module along the guideway from the access port to the transfer port.

17. The method of claim 16 further comprising the steps of:
forming the lower end of the module with a planar surface defining a slant plane inclined at a slant angle α relative to the module axis, wherein the slant plane introduces a moment on the module as it moves downwardly under the influence of gravity in the bi-level tank to rotate the axis of the module through an angle ϕ measured from vertical, and wherein the rotation angle ϕ moves the module into a proper orientation for subsequent movement of the module by buoyancy upward toward the upper surface of the bi-level tank; and
forming the body portion with a first side and a second side, wherein the first and second sides respectively extend between the upper end and the lower end of the module, are parallel to each other, and are equidistant from the axis of the module.

18. The method of claim 17 further comprising the step of mounting an arresting guide with the guideway inside the bi-level tank below the access port and oriented therein at the rotation angle ϕ for arresting the downward movement of the module in the bi-level tank.

19. The method of claim 18 further comprising the steps of:
mounting a pivot guide on the arresting guide for rotation between a first orientation wherein the module is directed onto the arresting guide as the module descends into the bi-level tank, and a second orientation wherein the module is directed from the arresting guide with the guideway through the transfer port along the guideway for exit from the bi-level tank; and
activating the pivot guide between its first and second orientations.

20. The method of claim 19 wherein the slant angle α is less than 45° and the angle ϕ is established in a range between 20° and 45°.
